(19) United States
(12) Patent Application Publication
(10) Pub. No.: US 2019/0138864 A1
(43) Pub. Date: May 9, 2019

(54) SMART LABEL OR TAG HAVING A CONTINUITY SENSOR ON A SUBSTRATE HAVING A PREFERENTIAL TEARING DIRECTION AND SYSTEM INCLUDING THE SAME

(71) Applicant: Thin Film Electronics ASA, OSLO (NO)

(72) Inventors: Paul REYLAND, San Clemente, CA (US); Alex CHANDLER, Sunnyvale, CA (US)

(21) Appl. No.: 16/094,194

(22) PCT Filed: Apr. 18, 2017
(86) PCT No.: PCT/US2017/028128

§ 371 Date: Oct. 16, 2018

Related U.S. Application Data
(60) Provisional application No. 62/324,223, filed on Apr. 18, 2016.

(51) Int. Cl. G06K 19/04; G06K 19/077; G09F 3/03

(52) U.S. Cl. CPC G06K 19/04; G09F 3/0341; G09F 3/0335; G06K 19/07798

(57) ABSTRACT

A smart label including a communication device and a continuity sensor, and methods of manufacturing and using the same, are disclosed. The smart label includes a substrate having a preferential tearing direction, an antenna or display, an integrated circuit, and a sensing line configured to sense or determine a continuity state of a container on which the communication device is placed or to which the communication device is fixed or adhered. The sensing line has at least one section oriented perpendicularly or substantially perpendicularly to the preferential tearing direction of the substrate. The antenna is configured to receive a first wireless signal and/or transmit or broadcast a second wireless signal. The communication device (or integrated circuit) may further include a receiver and/or transmitter, in which case the integrated circuit may be configured to process the first wireless signal and/or information therefrom and/or generate the second wireless signal and/or information therefor. Alternatively, the smart label may include a display (and optionally a battery) instead of the antenna. The display may be configured to display the continuity state of the container.

### CROSS REFERENCE TO RELATED APPLICATION

This application claims the benefit of U.S. Provisional Pat. Appl. No. 62/324,223, filed on Apr. 18, 2016, incorporated herein by reference as if fully set forth herein.

### FIELD OF THE INVENTION

The present invention generally relates to the field(s) of product security and authentication. More specifically, embodiments of the present invention pertain to a label having an electronic tag and/or device (which may communicate wirelessly) and a continuity sensor thereon with a mechanism for effectively tearing or removing a portion of the label substrate containing at least part of the continuity sensor from a container and/or package, and methods of manufacturing and using the same.

### DISCUSSION OF THE BACKGROUND

Current near field communication (NFC) base films use a relatively durable film that does not promote tearing. In cases where the base film is to be torn or separated (e.g., for security purposes), the base films require perforations, cuts, or scores to help tear the film.

Conventionally, packaging label designers must determine a particular placement of the base film or label to ensure tearing of base film or label when the packaging is opened. A Machine Direction Oriented (MDO) film tears cleanly and linearly in only one direction, along the web or around the web. Generally, a “machine direction” refers to an orientation direction of the web. In manufacturing of MDO films, the tearing direction of the film (which is along the web) and the machine direction are the same.

Generally, tamper evident seal functions are commercially available. For example, MDO films with predictable tearing properties have been used in tamper evident labels.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention generally relates to the field(s) of product security and authentication. More specifically, embodiments of the present invention pertain to a label having an electronic tag and/or device and a continuity sensor thereon with a mechanism for effectively tearing or removing a portion of the label substrate containing at least part of the continuity sensor from a container and/or package. The tag or device may communicate wirelessly, or alternatively, the label may include a display. The present invention also relates to methods of manufacturing and using the same.

In one aspect, the present invention relates to a wireless communication device that includes a substrate having a preferential tearing direction, a receiver and/or transmitter on the substrate, an antenna on the substrate configured to receive a first wireless signal and/or transmit or broadcast a second wireless signal, an integrated circuit on or over the substrate configured to (i) process the first wireless signal and/or information therefrom and/or (ii) generate the second wireless signal and/or information therefor, and a sensing line on the substrate. The sensing line is configured to sense or determine a continuity state of a package or container on which the communication device is placed or to which the communication device is fixed or adhered. In addition, the sensing line may have at least one section oriented perpendicularly or substantially perpendicularly to the preferential tearing direction. The integrated circuit has a first set of terminals electrically connected to the antenna, and a second set of terminals electrically connected to the sensing line. The second set of terminals is different from the first set of terminals. Alternatively, the communication device may include a display and a battery, instead of the antenna and the receiver and/or transmitter.

In exemplary embodiments of the present invention, the substrate includes a tab adjacent or proximate to the sensing line. The tab is configured to enable tearing the substrate in the preferential tearing direction and across the sensing line. In alternative or further embodiments, at least one slit, notch, score and/or perforation is immediately adjacent to the tab and/or the sensing line, and may at least partially define the tab. The slit, notch, score and/or perforation is configured to facilitate tearing the substrate and removing at least part of the sensing line. In one example, two slits, notches, scores and/or perforations may be immediately adjacent to and/or may partially define the tab.

In various embodiments of the present invention, the substrate comprises a machine direction oriented film. In further embodiments, the substrate comprises a label. In exemplary embodiments of the present invention, an adhesive is on the substrate. For example, the adhesive on (e.g., under) one or more first areas of the substrate other than the tab may have full adhesive strength, and the adhesive on (e.g., under) the tab may have less than full adhesive strength. Typically, the adhesive on the second area of the substrate has about 25-75% of the adhesion or adhesive strength of the adhesive on the first area of the substrate. In one example, the adhesive on the second area of the substrate has about 40-60% (e.g., 50%) of the adhesion or adhesive strength of the adhesive on the first area of the substrate. The adhesive in the first area may be the same as or different from the adhesive in the second area, but is preferably the same.

In some embodiments of the present invention, the wireless communication device includes a near field and/or radio frequency communication device. In exemplary embodiments, the integrated circuit includes a continuity sensor electrically connected to the sensing line. In such embodiments, the integrated circuit may further include a memory including one or more bits configured to store a value corresponding to a continuity state of the container or package.

In various embodiments of the present invention, the integrated circuit includes one or more printed layers and/or one or more thin films. In additional or alternative embodiments, the antenna consists of a single metal layer. In one example, the antenna and the sensing line consist of the single metal layer.

In another aspect, the present invention relates to a method of manufacturing a wireless communication device that includes forming an antenna on a substrate having a preferential tearing direction, forming a sensing line on the substrate, forming an integrated circuit on or over the substrate, and electrically connecting the antenna to a first set of terminals of the integrated circuit and the sensing line to a second set of terminals of the integrated circuit. The antenna is configured to receive and/or transmit or broadcast a wireless signal. The sensing line is configured to sense or determine a continuity state of a package or container on which the communication device is placed or to which the communication device is fixed or adhered. The sensing line also has at least one section oriented perpendicularly or substantially perpendicularly to the preferential tearing direction. Alternatively, the method may form a communication device by forming a display and a battery on the substrate, instead of the antenna and the receiver and/or transmitter. In either case, the method may further comprise sensing or determining a continuity state or a package or container on which the communication device is placed or to which the communication device is fixed or adhered.

In exemplary embodiments, the method includes forming a tab in the substrate adjacent or proximate to the sensing line. The tab is configured to tear the substrate in the preferential tearing direction and across the sensing line. In various embodiments, forming the tab includes slitting, notching, scoring and/or perforating the substrate in a direction perpendicular to the sensing line and parallel with the preferential tearing direction.

In exemplary embodiments, the substrate includes a machine direction oriented film and may comprise (or further comprise) a label. In various embodiments, the method may further comprise applying an adhesive on the substrate. For example, the adhesive may be applied on (e.g., under) first and second areas of the substrate. Typically, the second area of the substrate includes the tab. Generally, the adhesive in the second area of the substrate has 25-75% of the adhesion of the adhesive in the first area of the substrate.

In one example, the adhesive in the second area of the substrate has 40-60 (e.g., 50%) of the adhesion of the adhesive in the first area of the substrate.

In exemplary embodiments, forming the integrated circuit comprises printing one or more layers of the integrated circuit and/or forming one or more layers of the integrated circuit by one or more thin film processing techniques. For example, in one embodiment, forming the integrated circuit comprises printing all of the layers of the integrated circuit. In other embodiments, forming the integrated circuit comprises printing one or more layers of the integrated circuit and forming the remaining layers of the integrated circuit by thin film processing.

In some embodiments, forming the antenna consists of forming a single metal layer on the substrate, and etching the single metal layer to form the antenna. Alternatively, forming the antenna may comprise printing a metal ink on the substrate in a pattern corresponding to the antenna. In various embodiments, the antenna and the sensing line may be formed at the same time using a single, common metal layer on the substrate. Alternatively, forming the display may comprise forming a photoactive layer on the same or different substrate, and forming a plurality of electrodes thereto (at least one of which may be transparent). When the photoactive layer and the electrodes are not formed on a transparent substrate (or transparent window in the substrate), the method may further comprise forming a transparent window over the photoactive layer and the electrodes. In addition, forming the battery on or over the substrate may comprise forming a first current collector layer, a cathode or anode thereon, an electrolyte layer on the cathode or anode, the other of the cathode or anode on the electrolyte layer, and a second current collector layer on the other of the cathode or anode. The layers of the battery may be formed by printing and/or thin film processing. The battery may be configured to provide power to the integrated circuit and the display.

In a further aspect, the present invention relates to a package or container including first and second separable parts with an interface between the separable parts, with the (wireless) communication device discussed above thereon. The substrate is positioned on each of the first and second separable parts and over the interface. The antenna and integrated circuit of the wireless communication device are on one of the first and second separable parts of the package or container. In addition, the preferential tearing direction of the substrate is perpendicular or substantially perpendicular to the sensing line and the interface may be perpendicular or substantially perpendicular to the sensing line. The package or container may comprise a box, a tray with a lid, a bottle, an envelope or a bag.

In exemplary embodiments, the substrate comprises a tab adjacent or proximate to the sensing line that is configured to tear in the preferential tearing direction and across the sensing line. In one example, the sensing line is on the same separable part of the package or container as the antenna and the integrated circuit. Additionally or alternatively, the sensing line is on the first and second separable parts of the package or container and over the interface. In various embodiments, the package or container comprises multiple sealed or closed compartments, the sensing line comprises a plurality of the sensing lines, and each of the plurality of sensing lines extends over a unique one of the multiple sealed or closed compartments.

In an even further aspect, the present invention relates to a method of determining a continuity state of a package or container that includes placing a substrate on the package or container and over an interface between first and second separable parts of the package or container, and using an integrated circuit and continuity sensor on the substrate to sense the continuity state of the package or container. The substrate has a preferential tearing direction and a wireless communication device thereon comprising an antenna, the integrated circuit, and a sensing line. The sensing line is configured to sense or determine a continuity state of a package or container on which the communication device is placed or to which the communication device is fixed or adhered. In addition, the sensing line has at least one section oriented perpendicularly or substantially perpendicularly to the preferential tearing direction. In exemplary embodiments, the substrate comprises a tab or one or more slits, notches, scores, and/or perforations in the substrate adjacent or proximate to the sensing line that is configured to facilitate tearing the substrate in the preferential tearing direction and across the sensing line.

In various embodiments, placing the substrate on the container or package includes adhering the substrate to the container or package. For example, adhering the substrate to the container or package may include applying an adhesive on the substrate. For example, the adhesive may be applied to a first area of the substrate that includes one or more areas other than the tab at full strength, and to a second area of the substrate that includes the tab such that the adhesive has less than full strength. In one example, a first part of the substrate including the antenna or display, the integrated circuit, and at least part of the sensing line is adhered to a first separable part of the container or package, and a second part of the substrate is adhered to a second separable part of the container or package such that the substrate is over an interface between the first and second separable parts of the container or package. In some embodiments, the method of determining a continuity state of the package or container includes adhering (i) a first part of the substrate including the antenna or display, and the integrated circuit to the first separable part of the container or package and (ii) a second part of the substrate including at least part of the sensing line to the second separable part of the container or package, such that the tab is on or over the interface. In further embodiments, the method of determining a continuity state of the package or container includes tearing the tab in the preferential tearing direction toward the sensing line. In exemplary embodiments, tearing the tab comprises tearing and/or removing a part of the sensing line adjacent or proximate to the tab. In various embodiments, the method further comprises displaying a continuity state on the display.

The present invention advantageously provides ease for consumers opening packages, reduces the likelihood of a counterfeiter removing a label for placement on a generic container or opening a container or package to replace authentic goods with counterfeit goods, and greatly increases the ease and likelihood of tearing the sensing line connected to the continuity sensor. In addition, the present invention advantageously ensures a cleaner tear and better control of the tear across the sensing line, which provides reliable function of the NFC continuity sensor. These and other advantages of the present invention will become readily apparent from the detailed description of various embodiments below.

### BRIEF DESCRIPTION OF THE DRAWINGS

FIG. 1A shows an exemplary “smart label” placed on a container in accordance with one or more embodiments of the present invention. FIG. 1B shows an exemplary tear direction of the substrate of FIG. 1A.

FIGS. 2A-D show variations of an exemplary smart label in accordance with one or more embodiments of the present invention.

FIG. 3 shows another exemplary smart label placed on a jar in accordance with one or more embodiments of the present invention.

FIG. 4 shows an exemplary multi-compartment container having an alternative smart label with multiple continuity sensors thereon in accordance with one or more alternative embodiments of the present invention.

FIGS. 5A-B show other variations of the exemplary smart label of FIGS. 2A-D in accordance with further embodiments of the present invention.

FIGS. 6A-B show an exemplary smart label with a display in accordance with one or more embodiments of the present invention.

FIG. 7 shows an exemplary integrated circuit for use in the present wireless communication device.

FIG. 8 shows a flow chart for an exemplary method of manufacturing a substrate having a wireless communication device with a continuity sensor therein in accordance with one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

Manufacturing an NFC antenna and/or integrated circuit on an MDO film with a sense line across or perpendicular to the tear direction yields a finished product that advantageously promotes tearing across the sense line. When the NFC circuitry is integrated with the MDO film label, the label material should tear preferentially in one direction. Therefore, the integration of the present NFC device and an MDO base film and/or label material is an advantageous system.

### Exemplary Smart Labels with a Wireless Communication Device and a Continuity Sensor thereon

The present invention relates to a substrate having an electronic tag and/or device thereon with a mechanism for detecting an opened or tampered state of a package or container to which the substrate is attached. The substrate has a preferential tearing direction. In one embodiment, the tag or device communicates wirelessly. The wireless communication device generally includes a receiver and/or transmitter on the substrate, an antenna on the substrate that is configured to receive a first wireless signal (e.g., from the reader) and/or transmit or broadcast a second wireless signal (e.g., from the transmitter), and an integrated circuit on or over the substrate. The integrated circuit is configured to (i) process the first wireless signal and/or information therefrom, and/or (ii) generate the second wireless signal and/or information therefor. A receiver and/or transmitter may be integrated into the integrated circuit. The integrated circuit with the integrated receiver and transmitter has a first set of terminals electrically connected to the antenna.

In addition, the wireless communication device includes a sensing line on the substrate. The sensing line is configured to sense or determine a continuity state of a package or container on which the communication device is placed or to which the communication device is fixed or adhered. The sensing line has at least one section oriented perpendicularly or substantially perpendicularly to the preferential tearing direction of the substrate, and is electrically connected to a second set of terminals of the integrated circuit different from the first set of terminals.

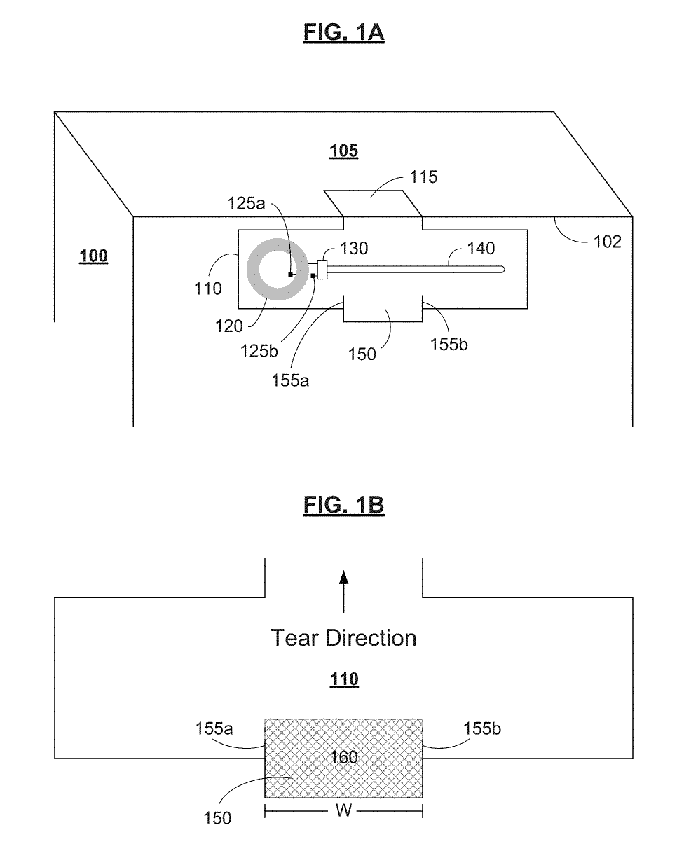

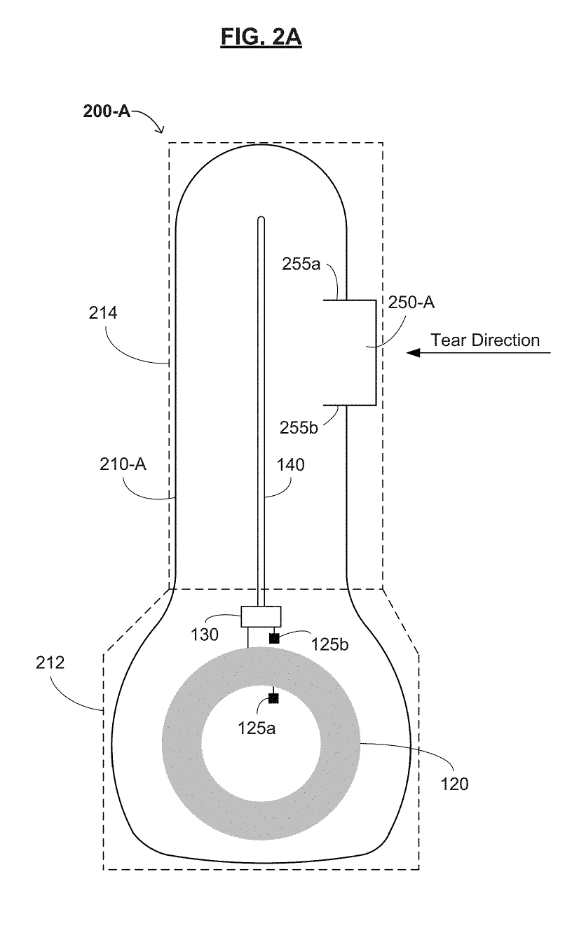

FIG. 1A shows an exemplary substrate 110 placed on a container 100 in accordance with one or more embodiments of the present invention. As shown in FIG. 1A, the container or package 100 is a box 100 with a hinged lid 105 thereon. The hinged lid 105 is secured in place by an extension 115 of the substrate 110. Security slits or perforations may be present in the substrate 110 along the interface between the box 100 and the lid 105 to ensure that the extension 115 is not removed from the lid 105, should it be desired to keep the extension 115 affixed to the container or lid 105. For example, if the section of the substrate 110 to be torn is not removed from the container 100 (e.g., the user merely tears through the sense line 140, but the torn part of the substrate 110 remains attached to the container 100), it is not necessary for the user to dispose of the torn part of the substrate 110.

Alternatively, the container or package may include a bottle, a jar, an envelope, a box with an unhinged (e.g., separate) lid, a bag or any other container capable or suitable for holding and/or containing an authentic product. Generally, the container 100 includes first and second separable parts having an interface 102 therebetween. Generally, the first separable part may include a fixed or non-opening part 100, such as the walls of a box or the body and/or neck of a bottle. The second separable part may include an opening or sealing mechanism, such as the lid 105 of the box, or a cap, cork, or other sealing device for a bottle.

The substrate 110 of FIG. 1 is rectangular or substantially rectangular, although the substrate 110 may have another shape suitable for a particular container (e.g., such as t-shaped, oval, elongated, rectangular or other quadrilateral [with or without rounded corners], tapered, or as otherwise described herein). In exemplary embodiments, the substrate 110 may comprise a machine direction oriented (MDO) film. Additionally, the substrate 110 may include the MDO film and a further layer comprising paper, a polymer (e.g., a high temperature polymer such as polyethylene naphthalate [PEN] or polyethylene terephthalate [PET], nylon, polyvinyl alcohol and copolymers thereof [e.g., ethylene-vinyl alcohol (EVOH) copolymers], polyvinyl chloride [PVC], polypropylene [PP], polychlorotrifluoroethylene [PCFE; e.g., ACLAR® pharmaceutical packaging film, available commercially from Honeywell], polyethylene [PE; e.g., high density PE (HDPE)]), a metal layer (e.g., comprising aluminum), or foil (e.g., comprising stainless steel or copper), a laminate or other combination thereof, etc. In exemplary embodiments, the substrate 110 may further include a label identifying the product inside the container and/or its manufacturer, and optionally providing additional information regarding the product.

The substrate 110 has a wireless communication device thereon that includes an antenna 120, an integrated circuit 130, and a sensing line 140. In one example, a first part of the substrate 110 including the antenna 120, integrated circuit 130, and the sensing line 140 may be on the first separable part of the container 100 (e.g., a wall of the container), and a second part 115 of the substrate 110 is on the second separable part of the container 100 (e.g., the lid 105) and over the interface 102 between the first and second separable parts of the container 100. Alternatively, the antenna 120 and the integrated circuit 130 may be on a first separable part or second separable part, and the sensing line 140 may be on the first and second separable parts and on or across the interface 102 therebetween. In such configurations, the sensing line 140 is perpendicular to the interface 102.

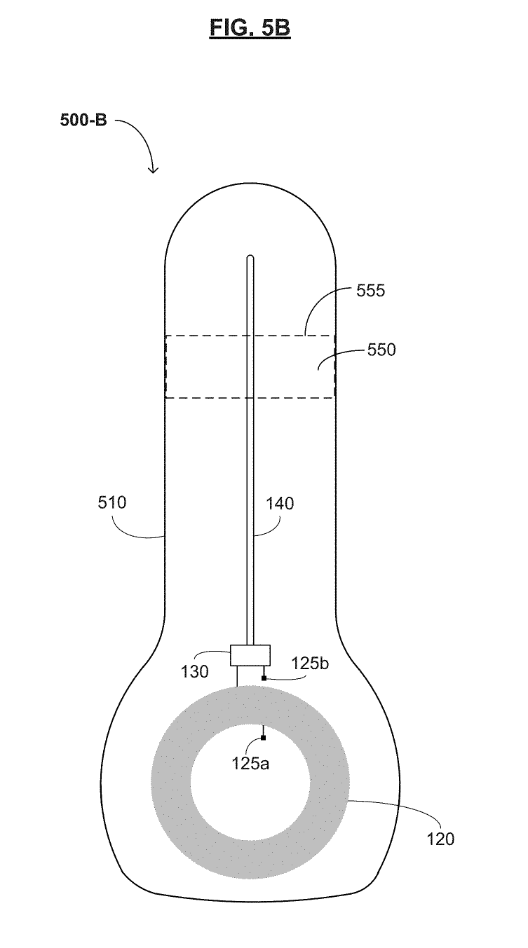

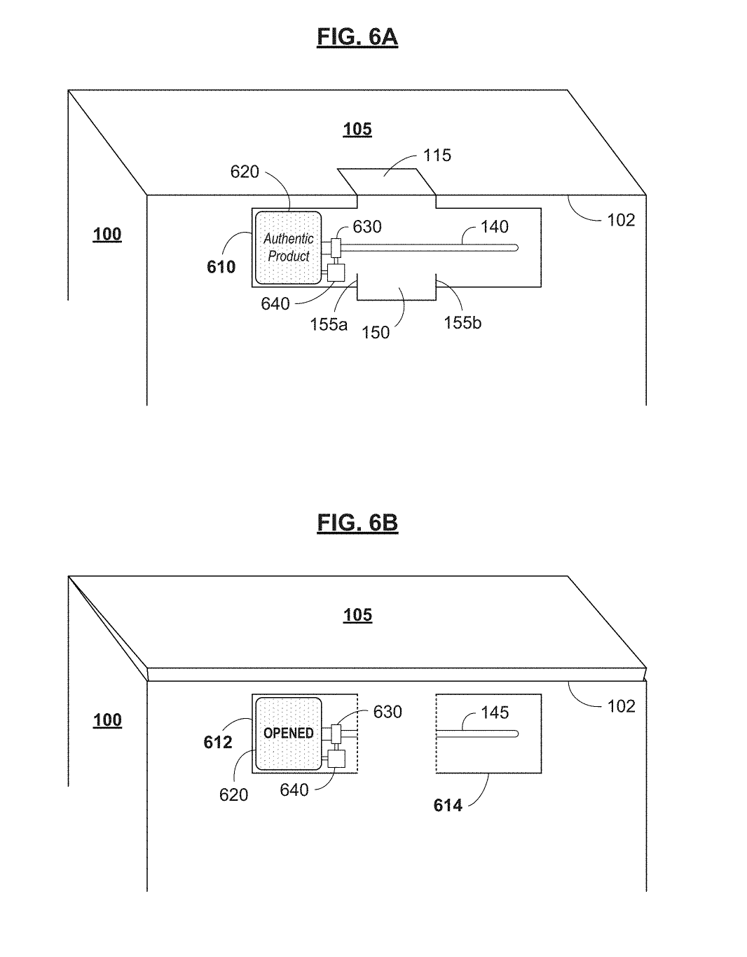

As shown in FIG. 1A, the substrate 110 includes a tab 150. The tab 150 may be adjacent or proximate to the sensing line 140. The tab 150 may comprise a pull tab that is incorporated into the substrate 100 with “starter cuts” (e.g., perforations, cuts, scores, holes, etc.) 155a-b in a direction perpendicular to the sense line 140. The tab 150 is configured to enable tearing the substrate 110 in the preferential tearing direction (see FIG. 1B) and across the sensing line 140 (see FIG. 1A). The tab 150 may be pulled across the sense line 140 to create one or more tears across the sense line 140. For example, referring to FIG. 1B, a tab 150 having a width W of, e.g., 20 mm generally removes a section of the sensing line 140 that is about 20 mm in length (see, e.g., FIG. 6B). In contrast, a single cut line (e.g., from a knife or other object cutting through the substrate 110, or from tearing along perforations in the substrate 110) merely cuts the sensing line 140 and introduces a possibility of an incomplete cut or inadvertent reconnection (if part of the substrate is not removed completely). On the other hand, when an appreciable section of the substrate 110 is removed entirely, it greatly increases the probability that the sensing line cannot be reconnected and that the torn section could cannot be replaced.

When the substrate comprises multiple MDO layers, films or planes, the sensing line 140 may be formed on each such MDO layer, film or plane, and electrically connected to a sensing line on an adjacent layer, film or plane by a contact or via in a hole or opening in the corresponding or intervening MDO layer, film or plane. Tearing across such multiple layers, films or planes ensures multiple tears through the sensing line 140 and provides greater security against attempts to replace the torn section to return the sensing line to a state corresponding to a closed container or package.

In various embodiments of the present invention, the substrate surface under the tab 150 has a lighter tack of adhesive 160 thereon (see FIG. 1B) to facilitate removal of the tab 150, while enabling the user to clasp the engineered tear point (e.g., tab 150 and the region of the substrate 110 between the cuts 155a-b). The remainder of the substrate 110 has adhesion on the underside with normal or typical adhesion properties. For example, as shown in FIG. 1B, the substrate 110 may include an adhesive thereon in a first area or region of the substrate other than the area under the tab 150 and between the cuts 155a-b with a first adhesion or adhesive strength, and in a second area or region 160 of the substrate under the tab 150 and between the cuts 155a-b with a second adhesion or adhesive strength. Generally, the adhesive in the second area 160 of the substrate has about 25-75% (e.g., 40-60%) of the adhesion or adhesive strength of the adhesive in the first area of the substrate. In one example, the adhesive in the second area 160 of the substrate may have an adhesive strength that is about 50% of the adhesive strength of the adhesive in the other areas of the substrate. In some embodiments, the second area 160 extends across the entire part of the substrate to be torn and/or removed. However, in one or more such embodiments, the adhesive in the extension region 115 may have full adhesion or adhesive strength. Generally, the same adhesive having different values of adhesion are in the different areas or regions of the substrates. Alternatively, a plurality of adhesives having different adhesion strengths may be in the different areas or regions of the substrate.

Referring back to FIG. 1A, the tab 150 may be defined in part by the slits, notches, scores and/or perforations 155a and 155b in the substrate 110. As shown in FIG. 1A, the slits, notches, scores and/or perforations 155a and 155b are immediately adjacent to the tab 150, but do not extend to the sensing line 140. To facilitate tearing the substrate 110 and the sensing line 140, the slits, notches, scores, and/or perforations 155a-b are oriented parallel with the preferred tear direction and perpendicular to the sensing line 140. In further embodiments, the slits, notches, scores and/or perforations may extend across the substrate 110 (e.g., to the extension region 115) and/or define the extension region 115 (e.g., by being positioned over and/or oriented along the interface 102).

In various embodiments, the antenna 120 may comprise a coil, concentric rings or a plurality of loops or “rings” in a spiral. For example, the number of loop or “rings” may be from about 4 to about 50. Alternatively, the shape of the antenna 120 may be a square, rectangular, oval or serpentine, and may have dimensions that match any of multiple form factors, while preserving compatibility with reader hardware (e.g., the NFC 13.56 MHz target frequency).

The antenna 120 may be printed (e.g., using a printed conductor such as, but not limited to, silver from a silver paste or ink) or formed using conventional methods such as blanket deposition and etching (e.g., by sputtering or evaporating aluminum on the substrate 110 and patterning by low-resolution [e.g., 10-1,000 μm line width] photolithography and wet or dry etching). Some or all portions of the sensing line(s) 140 may be patterned on the same or opposite side of the substrate as or from the antenna 120. Patterning the sensing line(s) 140 on the same side of the substrate as the antenna 120 advantageously facilitates simpler manufacturing processes and reduces the cost of manufacturing. Patterning the sensing line(s) 140 on the opposite side of the substrate as the antenna 120 electrically isolates the antenna 120 and the sensing line 140 from each other. The inner end of the antenna 120 may be electrically connected to a first pad 125a, which is conventionally connected to a second pad 125b that is electrically connected to a terminal on the integrated circuit 130. In one example, a strap is formed on the underside of the substrate 110 and bonded to the pads 125a-b through vias in the substrate. Alternatively, the strap can be formed on an interposer (i.e., an insulating substrate) and bonded to the pads 125a-b through vias in the interposer or in a dielectric layer formed over the strap. In a further alternative, the integrated circuit 130 can function as such a strap when formed on an electrically insulating interposer (a so-called “integrated interposer”).

In exemplary embodiments, the integrated circuit 130 includes a continuity sensor (not shown) electrically connected to the sensing line 140. The integrated circuit 130 may further include a memory (not shown) including one or more bits configured to store a value corresponding to a continuity state of the container or package 100.

The memory may also include a plurality of bits that store identification information (e.g., a device identification number), product information, information from at least one other sensor on the substrate 100, software instructions, etc. In some embodiments, the integrated circuit 130 includes one or more printed layers. For example, memory bits storing information that does not change (e.g., device identification information, instructions) may be formed by printing one or more layers of the memory, similar to a mask read-only memory (mask ROM). In one example, the integrated circuit is an “all-printed” integrated circuit (i.e., all or substantially all layers are printed layers). In further embodiments, the integrated circuit 130 includes one or more thin films, as an alternative to or in combination with one or more printed layer(s).

In various embodiments of the present invention, the sensing line is electrically connected to the integrated circuit 130 and extends across a substantial length of the substrate 110, including the region adjacent to the tab 150 and regions on each side (e.g., to the left and right, as shown in FIG. 1A) of the tab 150. The sensing line 140 includes a metal or other electrical conductor. For example, the sensing line 140 may be made from a single metal layer in common with that of the antenna 120. Dimensions of the sensing line 140 may vary depending on the size and/or shape of the container or package 100.

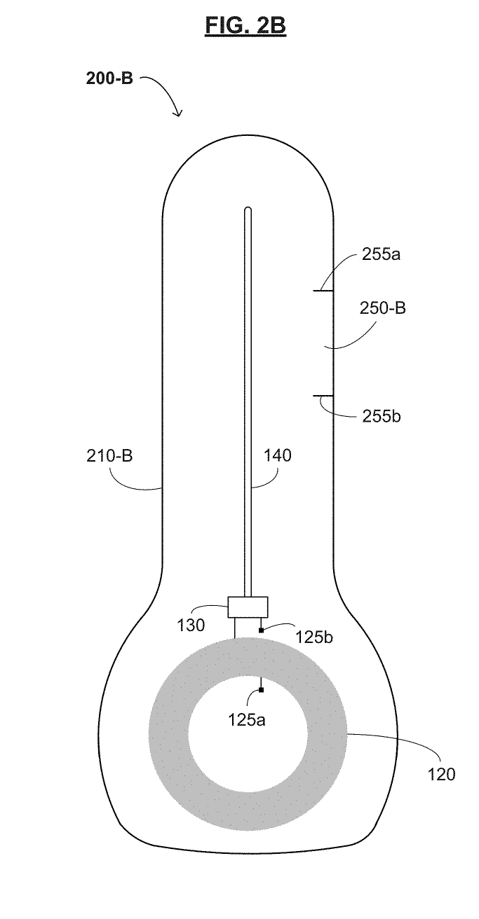

New features of the present invention advantageously include formation of the sense line 140 of the wireless communication device (e.g., the smart label's continuity sensor) on the substrate (e.g., an MDO film) 110, which promotes tearing of the sense line 140. Some or all electrical components on the substrate or label 110 can be formed on such a film 110, as long as the sense line 140 is formed on the MDO film 110. FIG. 2A shows an exemplary smart label 200-A including a substrate 210-A having a preferential tear direction in accordance with one or more embodiments of the present invention. The substrate 210-A of FIG. 2A includes the same or substantially the same material as substrate 110 of FIGS. 1A-B. Substrate 210 has an elongated, curved or “pear” shape, but it may have another shape depending on the type of container, the desired shape of the label, the dimensions of the antenna, etc.

Generally, the substrate 210-A may include a first part 212 that includes the antenna 120 and the integrated circuit 130, and a second part 214 that includes the sensing line 140. The substrate 210 of FIG. 2A is particularly suitable for bottles or jars, in which the first part 212 may be on the body, shoulder or neck of the bottle or jar, and the second part 214 may be on, over, or across a sealing mechanism (e.g., a cap, a lid, a cork, a shrink wrap, a capsule, etc.). Optionally, the second part 214 may be the shoulder of a bottle, or on opposite sides of the neck (and optionally, of the shoulder). Alternatively or additionally, the antenna 120 and integrated circuit 130 may be on the first part 212 of the substrate 110, which may comprise a paper/polymer laminate, high temperature polymer and/or metal foil, and the sense line 140 may be on the second part 214 of the substrate 110 comprising the MDO film 110.

In one example, the first part 212 of the substrate 210-A may include a PET or other high-temperature polymer film on which the antenna 120 and the integrated circuit 130 are formed, and the second part 214 of the substrate 210-A may include the MDO film on which the sensing line 140 is formed. Ends of the sensing line 140 may be conventionally connected or bonded to pads or other terminals on the integrated circuit 130, or to a separate pad similar to pads 125a-b connected to a terminal on the integrated circuit 130 by a trace on the substrate 210-A.

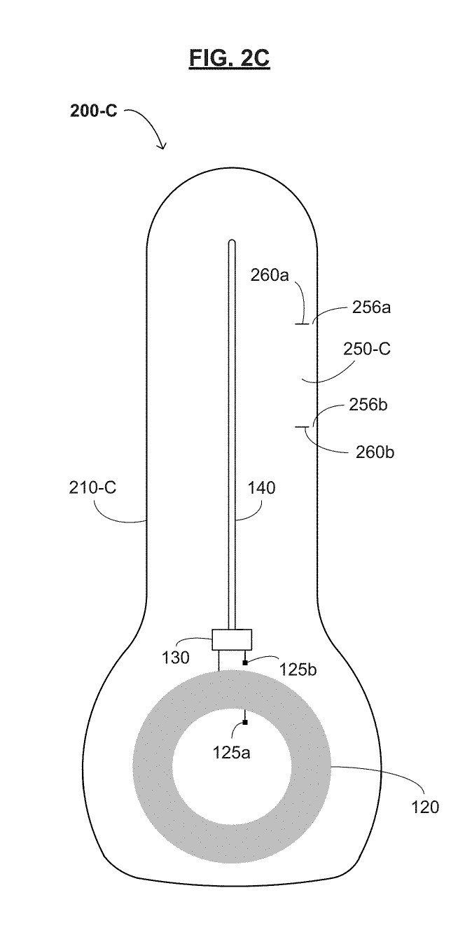

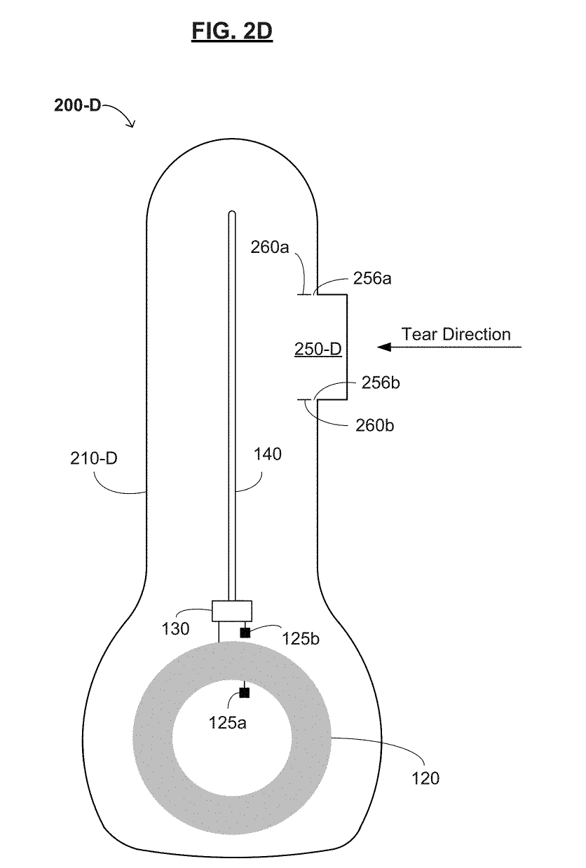

The first part 212 of the substrate 210-A including the antenna 120 and the integrated circuit 130 may be on or over a first separable part of the container. For example, the first part of the container may include a wall of the container, as shown in FIG. 1A, a jar as shown in FIG. 3, or a body or a neck of a bottle (not shown). The second part 214 of the substrate 210-A including the sensing line 140 may be on or over a second separable part of the container (e.g., a lid or sealing device of the container) and over an interface between the first and second separable parts of the container. The second part 214 may also be, in part, on the first separable part of the container.

In exemplary embodiments of the present invention, the substrate 210-A includes a tab 250 in the second part 214 of the substrate 210-A. Generally, the tab 250-A in this embodiment is over the interface between the separable parts of the container. The tab 250 is adjacent or proximate to the sensing line 140. The tab 250-A is configured to enable tearing the substrate 210-A in the preferential tearing direction and across the sensing line 140, as shown in FIG. 2A. Similarly to the substrate 110 of FIG. 1A, substrate 210-A may have an adhesive thereunder. The adhesive may have a first adhesion or adhesive strength in areas of the substrate other than the tab 250-A and between the cuts 255a-b, in which areas the adhesive may have a second adhesion or adhesive strength (e.g., as shown in FIG. 1B). As described above, the adhesive in the tearing region of the substrate (e.g., under the tab 250-A) may have about 25-75% of the adhesive strength (e.g., 40-60%, and in one example, about 50%) of the adhesive in the other areas of the substrate.

As shown in FIG. 2A, the tab 250-A is defined at least in part by slits, notches, scores and/or perforations (e.g., starter cuts) 255a and 255b. As shown in FIG. 2A, the slits, notches, scores and/or perforations 255a and 255b are immediately adjacent to the tab 250-A.

The direction or orientation of the slits, notches, scores and/or perforations 255a-b is configured to facilitate tearing the substrate 210-A in the preferred tearing direction of the substrate 210-A (e.g., parallel to the preferred tearing direction of the substrate 210-A and perpendicular to the sensing line 140).

In various embodiments, the antenna 120 and the integrated circuit 130 are on the first part 212 of the substrate 210-A. Generally, the first part 212 of the substrate 210-A will have dimensions and/or a shape suitable for the antenna 120. In one example, the first part 212 of the substrate 210-A is circular or substantially rounded, as shown in FIG. 2A. Other shapes for the first part 212 of the substrate 210-A include oval, square, polygonal, and/or irregular, but are not limited thereto.

In various embodiments, the sensing line 140 is electrically connected to the integrated circuit 130 and is on the second part 214 of the substrate 210-A. The sensing line 140 may extend across most of the length of the second part 214 of the substrate 210-A. Dimensions of the sensing line 140 and/or the second part 214 of the substrate 210-A may vary depending on the size and/or shape of the container or package.

FIG. 2B shows another exemplary smart label 200-B including a substrate 210-B in accordance with one or more embodiments of the present invention. The substrate 210-B of FIG. 2B includes the same or substantially the same material as substrate 210-A of FIG. 2A. As shown in FIG. 2B, a peripheral border or edge of the tab 250-B is aligned or substantially aligned with a peripheral border or edge of the substrate 210-B. Having the peripheral border or edge of the tab 250-B aligned with the peripheral border or edge of the substrate 210-B advantageously improves esthetic appearance of the label 200-B and reduces the risk of accidental tearing or removal of the tab 250-B and sensing line 140.

FIG. 2C shows another exemplary smart label 200-C including substrate 210-C in accordance with one or more embodiments of the present invention. The substrate 210-C of FIG. 2C includes the same or substantially the same material and shape as substrates 210-A and 210-B of FIGS. 2A-B.

The substrate 210-C includes slits, notches, scores and/or perforations (e.g., starter cuts) 260a, 260b adjacent to or near a peripheral border or edge of the substrate 210-C, resulting in gaps 256a, 256b between the peripheral border or edge of the substrate 210-C and the cuts 260a, 260b. Although, the area of the substrate 210-C between the starter cuts 260a, 260b and the gaps 256a, 256b is known as perf ties or ties in the art, in general, the area or region of the substrate to be removed (e.g., between the tabs 150, 250-A and 250-B and the opposite edge of the substrates 110, 210-A or 210-B in FIGS. 1A, 2A and 2B, respectively) can be considered a “tearing region” In addition, the starter cuts 260a, 260b may be adjacent to the sensing line 140 (i.e., between the peripheral border of the substrate 210-C and the sensing line 140). The substrate 200-C enables a greater degree of symmetry (e.g., between the left and right halves), thereby simplifying the manufacturing process. The substrate 200-C also advantageously retains substantially all of the mechanical strength of substrate 210-C in the tearing region during application of substrates to container (e.g., in the bottling or packaging process).

As shown in FIG. 2C, each gap 256a and 256b is between each starter cut 260a and 260b and the peripheral border or edge of the substrate 210-C. The cuts 260a and 260b effectively define the tearing region 250-C. The tearing region 250-C is configured to tear the substrate 210-C in the preferential tearing direction and across the sensing line 140. Having no cuts in the peripheral border or edge of the substrate 210-C maximizes the esthetic appearance of the label 200-C, and the gaps 256a-b between the cuts 260a-b and the peripheral border or edge of the substrate 210-C minimizes the accidental tearing or removal of the substrate in the tearing region 250-C.

FIG. 2D shows another exemplary smart label 200-D including substrate 210-D in accordance with one or more embodiments of the present invention. The substrate 210-D of FIG. 2D includes the same or substantially the same material and shape as substrates 210-A, 210-B and 210-C of FIGS. 2A-C. The substrate 210-D includes a tab 250-D in the second part 214 of the substrate 210-D. The tab 250-D is similar to the tab 250-A of FIG. 2A, but with gaps 256a, 256b between starter cuts 260a, 260b and the tab 250-D, similar to the substrate 210-C in FIG. 2C.

FIG. 3 shows another exemplary smart label including a substrate 310 placed on a container 300 in accordance with one or more embodiments of the present invention. As shown in FIG. 3, the container or package 300 includes a jar 320 with a cap or lid 305 (e.g., a screw cap) thereon. Generally, the jar 320 and the cap or lid 305 have an interface 302 therebetween.

The substrate 310 of FIG. 3 includes the same or substantially the same material(s) and shape(s) as substrates 210-A, 210-B, 210-C and 210-D of FIGS. 2A-D. Generally, the antenna 120 and the integrated circuit 130 are on one of the separable parts of the container 300 (i.e., the jar 320), and the sensing line 140 is on both the first and second separable parts of the container 300 and on or over the interface 302. The substrate 310 includes a tab 350 with starter cuts similar to the tab 250-A of FIG. 2A. The tab 350, which is configured to enable tearing the substrate 310 in the preferential tearing direction and across the sensing line 140, is on or over the interface 302.

### An Exemplary Smart Label with a Wireless Communication Device and Continuity Sensor for a Sealed Multi-Compartment Container

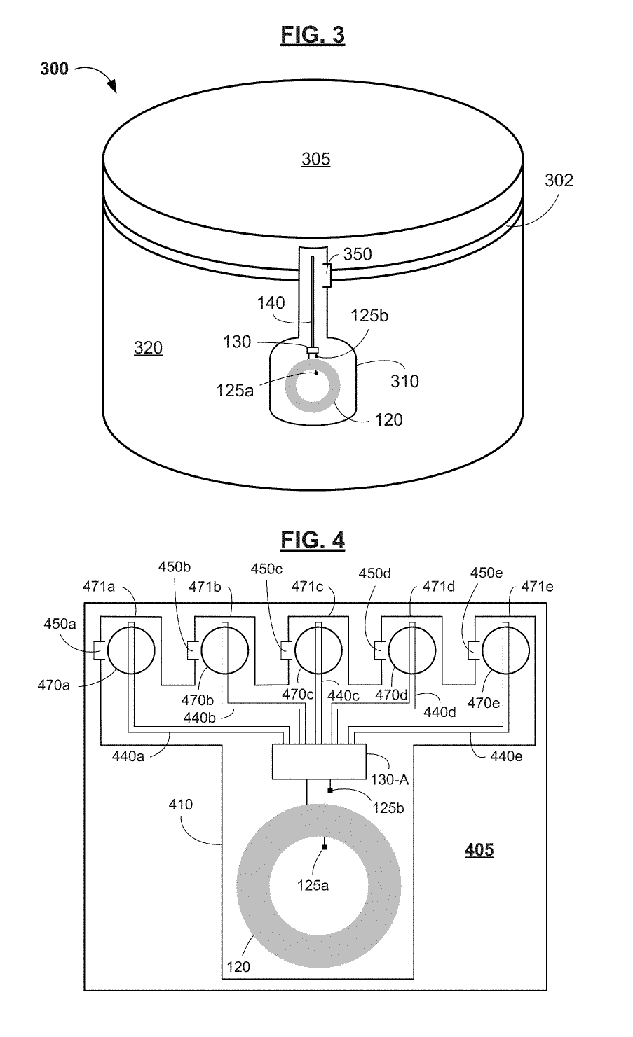

FIG. 4 shows an exemplary blister pack including a “smart seal” in accordance with one or more embodiments of the present invention. Generally, the blister pack includes a plurality of compartments or wells 470a-e in a tray or other surface 405. The blister pack is particularly suited for various medicinal or pharmaceutical products that may be taken according to a schedule (e.g., once per day).

The “smart seal” comprises a substrate 410 with an antenna 120, an integrated circuit 130-A, and a plurality of sensing lines 440a-e thereon. The antenna 120 and each of the sensing lines 440a-e are electrically connected to the integrated circuit 130-A in the same or substantially the same way as the antenna and sensing line 140 in FIGS. 1A and 2A-D.

The substrate 410 includes a plurality of sealing flaps 471a-e. Each of the compartments 470a-e are sealed or closed with a corresponding sealing flap 471a-e, respectively. As shown in FIG. 4, each of the sensing lines 440a-e extends over a unique, corresponding compartment 470a-e. Each sensing line 440a-e is connected to the integrated circuit 130-A (and, in general, to a unique continuity sensor in the integrated circuit 130-A) through separate terminals. Tabs 450a-e formed in the substrate 410 are configured to tear the corresponding sealing flap 471a-e in the preferred tearing direction of the substrate 410 and across the corresponding sensing line 440a-e.

### Alternative Smart Labels with a Wireless Communication Device and Continuity Sensor thereon

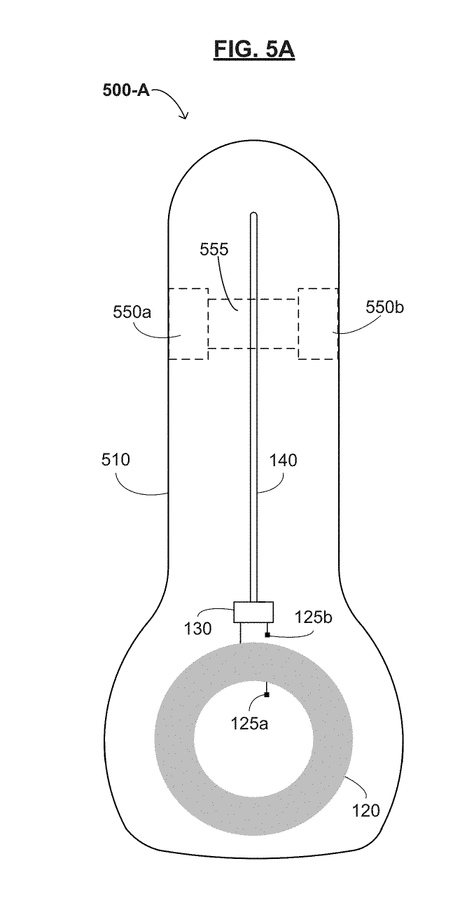

FIG. 5A shows another exemplary smart label 500-A including a substrate 510 with a continuity sensor therein in accordance with one or more embodiments of the present invention. The substrate 510 of FIG. 5A includes the same or substantially the same material as substrates 210A-D of FIGS. 2A-D and has the same or substantially the same shape as substrates 210B-D of FIGS. 2B-D. However, in label 500-A of FIG. 5A, the tab is replaced with an adhesive pattern (on the underside) that provides a similar effect as the tab.

For example, the adhesive pattern on the substrate 510 may include first and/or second lifting or grasping regions 550a-b, a tearing region 555, and the remainder of the substrate 510. The adhesive may have its full adhesive strength in areas other than the lifting or grasping regions 550a-b and the tearing region 555. The adhesive in the tearing region 555 may have an adhesive strength about 25-75% (e.g., 40-60%, and in one example, about 50%) of the adhesive strength of the adhesive in the other areas of the substrate. However, the lifting or grasping regions 550a and 550b have very little or no adhesive strength or adhesion (e.g., less than 20%, less than 10% or 0% of the full adhesive strength of the adhesive). In one example, lifting or grasping regions 550a and 550b may have no adhesive thereunder, and tearing region 555 may have an adhesive strength or adhesion with 50% of adhesive strength or adhesion of the adhesive.

In some embodiments, the adhesive may be printed on the underside of the substrate 510. Different adhesive strengths in different areas of the substrate 510 may be achieved or created by monitoring the amount of adhesive printed in the printing process. For example, a first amount of the adhesive may be printed in the areas of the substrate other than the tearing region, and a second amount of adhesive printed in the tearing region of the substrate, the second amount of adhesive being less than the first amount of adhesive. In some examples, the second amount of adhesive may be 25-75% (e.g., 50%) of the first amount. In another example, the second amount is zero. Alternatively, post-printing removal of adhesive (e.g., using a solvent or deadening agent) in the tearing region can be performed.

A configuration such as that show in FIG. 5A advantageously allows a user to slide a finger or a tool (such as a knife blade or a coin) under either of the lifting or grasping regions 550a and 550b, grasp and/or lift the substrate 510 in the region 550a or 550b, then pull the substrate 510 in the preferential tearing direction (and across the sensing line 140). The substrate 510 comes off the container or package relatively easily due to the reduced adhesive strength of the adhesive in the tearing region 555 and the absence or near-absence of adhesive in the lifting or grasping regions 550a and 550b.

FIG. 5B shows yet another exemplary smart label 500-B including a substrate 510 with a continuity sensor thereon in accordance with one or more embodiments of the present invention. The substrate 510 of FIG. 5B includes the same or substantially the same material as substrates 210A-C and 410 of FIGS. 2A-D and 5A.

In exemplary embodiments, the substrate 510 may have an adhesive thereon in a pattern with a first adhesive strength in areas other than a tearing region 550, and a second adhesive strength in the tearing region 550, as shown in FIG. 5B. As described above, the second adhesive strength may be about 25%-75% (e.g., 40-60%) of the first adhesive strength (and in one example, about 50%). Alternatively, the tearing region 550 may have no adhesive. The tearing region 550 of FIG. 5 maximizes the esthetic appearance and mechanical strength of the label 500-B, and advantageously allows a user to slide a finger or a tool under the tearing region 550, then grasp the substrate 510 and pull it in the preferential tearing direction (and across the sensing line 140), which comes off the container or package relatively easily due to the reduced adhesive strength (or absence) of the adhesive in tearing region 550.

### An Exemplary Smart Label with a Display Device and Continuity Sensor Thereon

FIG. 6A shows an exemplary substrate 610 for a smart label including a display 620 thereon, showing the continuity state of the container 100. The substrate 610 also includes an integrated circuit 630, a battery 640, and the sensing line 140. The sensing line 140 is the same as the sensing line 140 in FIGS. 1A, 2A-C, 4 and 5. The integrated circuit 630 is substantially the same as the integrated circuit 130 in FIGS. 1A, 2A-C, 4 and 5, but does not include a receiver, transmitter, or other circuitry configured to process a wireless signal. The integrated circuit 630 is also powered by the battery 640, so the integrated circuit 630 does not include power extraction circuitry, such as a rectifier.

The substrate 610 has a preferential tearing direction, and includes a tab 150 and slits or starter cuts 155a-b, the same as the substrate 110 in FIG. 1A. Thus, in some embodiments, the substrate 610 comprises an MDO film.

The display 620 receives a power supply from the battery 640 and instructions and/or data from the integrated circuit 630. The display 620 is, in some embodiments, relatively simple, and may comprise an electrochromic display (ECD), an electroluminescent display (ELD), a liquid crystal display (LCD), or a dot-matrix display. For example, the integrated circuit 630 may send a simple “on/off” instruction (e.g., in the form of a binary logic signal) to the display 620. Alternatively, the display 620 may be relatively complex, and may comprise a thin film transistor liquid crystal display (TFT LCD), an organic light-emitting diode (OLED) display, electronic paper, a light-emitting diode (LED)-backlit LCD display, etc. Thus, the photoactive layer may comprise an electrochromic layer, an electroluminescent layer, a liquid crystal layer, or organic or inorganic LED layers, alone or in combination with a plurality of thin film transistors and/or LED backlighting, etc.

The display 620 may show the continuity state of the container 100 by displaying a text message or other visual indication, such as “Authentic Product” when the container 100 remains sealed from the time of factory production or packaging. The display 620 may also show other information about the product or the conditions under which the product was shipped and/or stored, a message from the manufacturer or reseller, etc.

In some embodiments, the substrate 610 may further comprise an antenna (not shown), and the integrated circuit may be further configured to process wireless signals to or from a reader (e.g., an RF- or NFC-enabled smart phone or tablet computer). In such embodiments, the manufacturer and/or reseller may send a message or other information to the consumer depending on the continuity state of the container 100. For example, when the continuity state of the container 100 is sealed (or its equivalent), the manufacturer and/or reseller may send product price information and/or information about other products with which the product in the container 100 may be advantageously used. On the other hand, when the continuity state of the container 100 is opened, the manufacturer and/or reseller may send use information for the product, such as instructions for assembly or use, recipes (for food or beverage products), etc. In a further embodiment, the display 620 further comprises a touch screen to enable the user to input information or data to send to manufacturer or reseller.

The battery 640 may be a conventional thin-film or printed battery, comprising a first current collector layer, a cathode, an electrolyte layer, an anode, and a second current collector layer. In general, the cathode is in electrical contact (and generally is in physical contact) with one of the first and second current collector layers, and the anode is in electrical contact (and generally is in physical contact) with the other of the first and second current collector layers. The electrolyte layer is between the cathode and the anode, and is generally in electrical and physical contact with each of the cathode and the anode.

FIG. 6B shows the substrate 612 after the tab 150 has been pulled in the preferential tearing direction, and a section of the substrate 610 (FIG. 6A) and the sensing line 140 have been removed, leaving a sensing line part 145 and a substrate part 614 on the container 100. In such a case, the display 620 may show a different continuity state of the container 100 by displaying a text message or other visual indication, such as “OPENED” when tab 150 and extension 115 of the substrate 612 have been removed from the container 100, enabling the container 100 to be opened.

### An Exemplary Integrated Circuit for the Wireless Communication Device

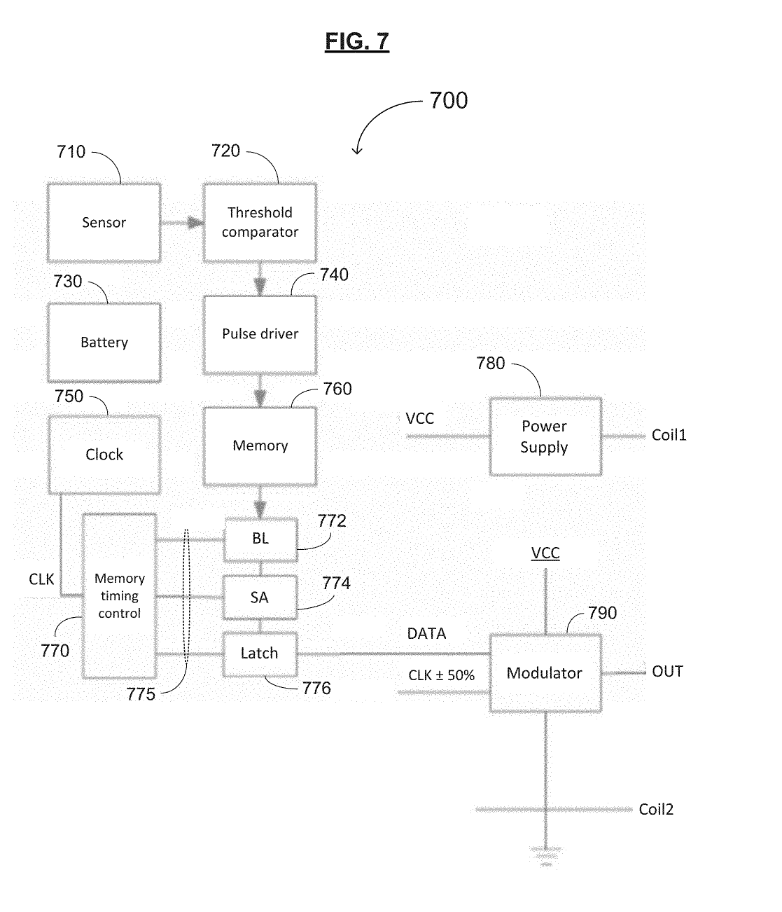

FIG. 7 shows an exemplary integrated circuit 700 for use in the present wireless communication device. The exemplary integrated circuit (IC) 700 for use with the present “smart label” includes one or more sensors 710, a threshold comparator 720 receiving information (e.g., a signal) from the sensor(s) 710, a pulse driver 740 receiving an output of the threshold comparator 720, a memory 760 storing sensor data from the pulse driver 740, one or more bit lines (BL) 772 for reading data from the memory 760, one or more sense amplifiers (SA) 774 for converting the signal(s) on the bit line(s) to digital signals, one or more latches 776 for temporarily storing data from the sense amplifier(s), and a transmitter (e.g., modulator) 790 configured to output data (including an identification code) from the device. The exemplary IC 700 in FIG. 7 also contains a clock 750 configured to provide a timing signal (e.g., CLK) that controls the timing of certain operations in the IC 700 and a memory timing control block or circuit 770 that controls the timing of memory read operations. The modulator 790 also receives the timing signal (CLK) from the clock circuit or a slowed-down or sped-up variation thereof. The exemplary IC 700 also includes a power supply block or circuit 780 that provides a direct current (e.g., VCC) to various circuits and/or circuit blocks in the IC. The memory 760 may also contain identification code. The portion of the memory 760 containing identification code may be printed. The IC 700 may further contain a receiver (e.g., a demodulator), one or more rectifiers (e.g., a rectifying diode, one or more half-bridge or full-bridge rectifiers, etc.), one or more tuning or storage capacitors, etc. Terminals in the modulator and the power supply are connected to ends of the antenna (e.g., at Coil1 and Coil2).

The memory in an NFC or RF identification device may contain a fixed number of bits. In some implementations, NFC tags may contain 128 or 256 bits. Some bits are allocated to overhead (non-payload) data for format identification and data integrity (CRC) checking. The payload of the device (e.g., the NFC or RF tag) consumes the remainder of the bits. For example, the payload can be up to 96 bits in the case of the 128-bit

NFC tag and up to 224 bits in the case of the 256-bit NFC tag.

The payload of the NFC tag can be allocated to variable amounts of fixed ROM bits (which are generally—but not always—used as a unique identification number). When print methods are used in manufacturing the NFC tag, the ROM bits are permanently encoded and cannot be electrically modified. Any payload bits that are not allocated as fixed ROM bits can be allocated as dynamic sensor bits (e.g., for the continuity sensor to which the sensing lines are connected). These sensor bits can change values, based on a sensed input. Different splits or allocations between ROM and sensor bits are indicated by data format bits that are part of the non-payload or ‘overhead’ bits, generally in the first 16 bits of the NFC tag memory.

One example of how continuity sensing may be implemented in the present invention involves a sensor 710 that detects when a sensing line (e.g., sensing line 140 in FIGS. 1A, 2A-C and 4-5 is broken. Upon such an event, one or more sensor bits in the memory 760 change state to reflect the broken or cut sensing line. This indicates to the reader (e.g., an NFC smartphone, etc.) that the protected container has been opened. The ROM ID bits do not change, but any data integrity bits (e.g., for CRC) may be updated to reflect the state of the sensor bits.

Continuity sensing generally refers to a capability and/or function that senses or determines whether a container has been tampered with or opened on the one hand, or remains in a closed state (e.g., its factory-sealed condition) on the other hand. In one embodiment, continuity sensing is implemented using at least one sensing line (e.g., sensing line 140 in FIGS. 1A, 2A-C and 4-5). The present communication device may be thought of as having two parts: a first part that includes the IC and the antenna (or display), and a second part that includes the sensing line(s). The part of the wireless communication device that includes the IC and antenna or display is on a first part of the protected container. The part of the communication device that includes the sensing line(s) may be on the same part of the container as the integrated circuit and the antenna or display, or may be at least partially on a second part of the protected container and/or a sealing device or mechanism such as a cap or lid that may move relative to the container (e.g., a bottle, jap or tray) upon opening. The tab or other mechanism configured to enable tearing of the substrates across the sensing line may be over an interface between the two parts of the container. Pulling the tab or other mechanism along or across the interface should break the sensing line(s).

In addition to a primary sensing line, the present wireless communication device may include one or more redundant sensing lines. The redundant sensing line(s) can be used in an “AND”-type function with the primary sensing line(s) (e.g., the IC and sensor sense that the bottle is opened only when all of the primary and redundant sensing lines are broken), or in an “OR”-type function with the sensing line(s) (e.g., the IC and sensor sense that the container is opened or has been tampered with when any of the primary and redundant sensing lines are broken). Alternatively, the sensing line and redundant sensing lines can provide one or more “partially-opened” continuity states when one or more of the primary and redundant sensing lines are broken and one or more of the primary and redundant sensing lines are not broken. One skilled in the art can easily derive logic and applications for such functionality and/or capability.

Of course, the IC 700 in the present device may include one or more other sensors in addition to the continuity sensor(s). For example, the IC 700 can further include one or more temperature sensors, humidity sensors, electromagnetic field sensors, current/voltage/power sensors, light sensors, and/or chemical sensors (e.g., for oxygen, carbon monoxide, carbon dioxide, nitrogen oxides, sulfur dioxide and/or trioxide, ozone, one or more toxins, etc.). The present IC may also include one or more time sensors (e.g., configured to count or determine elapsed time), which may include the clock circuit (which can be a basis for a real-time clock) and one or more counters, dividers, etc., as is known in the art. The leads from any external sensing mechanism should be connected to the IC at terminals separate from those for the antenna and the continuity sensor. Such sensors should be on the same part of the substrate as the antenna and the IC.

### An Exemplary Method of Manufacturing a Smart Label with a Communication Device and Continuity Sensor Thereon

The present invention also concerns a method of manufacturing a wireless communication device that includes forming an antenna on a substrate having a preferential tearing direction, forming a sensing line on the substrate, forming an integrated circuit on or over the substrate, and electrically connecting (i) the antenna to a first set of terminals of the integrated circuit, and (ii) the sensing line to a second set of terminals of the integrated circuit. The sensing line is configured to sense or determine a continuity state of a package or container on which the communication device is placed or to which the communication device is fixed or adhered, and has at least one section oriented perpendicularly or substantially perpendicularly to the preferential tearing direction. In addition, the antenna is configured to receive and/or transmit or broadcast a wireless signal. Alternatively, the method may form a communication device in which forming the antenna is replaced with forming a display.

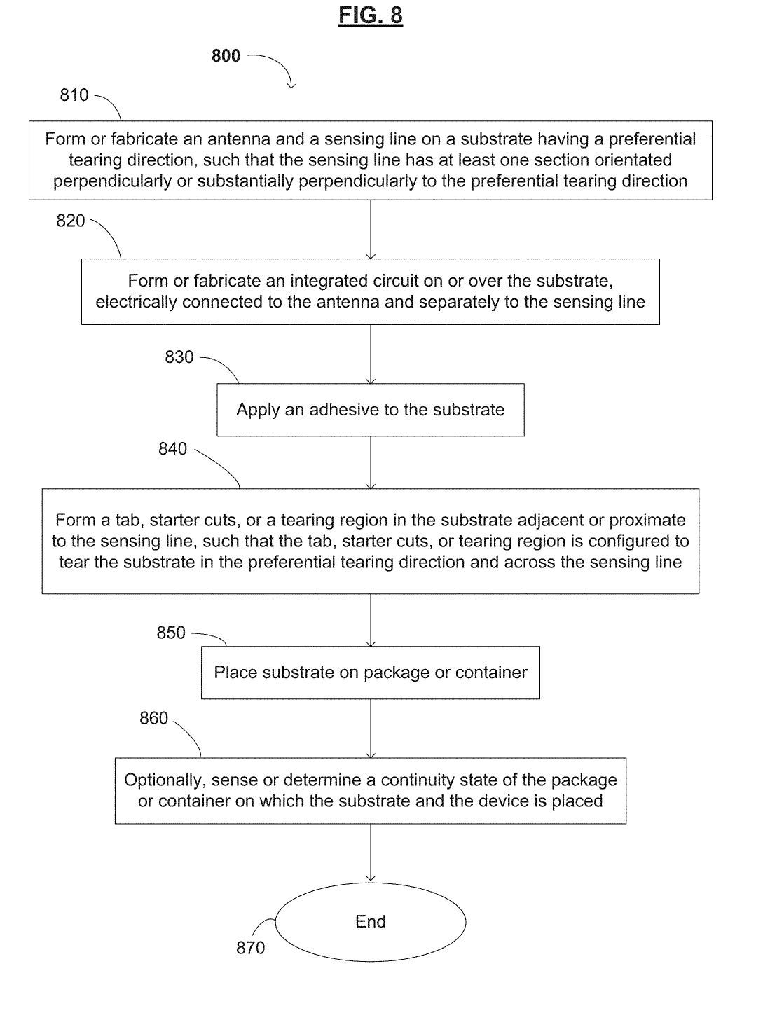

FIG. 8 shows a flow chart for an exemplary method 800 of manufacturing a wireless communication device (e.g., NFC and/or RF) in accordance with one or more embodiments of the present invention. The present method advantageously forms a “smart label” with a continuity sensor thereon that ensures a cleaner tear of the label or substrate and better control of the tear, which is useful for reliable function of the continuity sensor.

At 810, an antenna may be formed or fabricated on a surface of a substrate, the substrate having a preferential tearing direction. In some embodiments, forming the antenna may consist of forming a single metal layer on the substrate, and etching the single metal layer to form the antenna. In addition, a sensing line may be formed or fabricated on the substrate at the same time as or at a different time than the antenna. If formed at different times, the antenna and sensing line may be formed on the same or different substrates. The sensing line may have at least one section oriented perpendicularly or substantially perpendicularly to the preferential tearing direction.

In some embodiments, forming the antenna and sensing line(s) may consist of forming a single metal layer on the substrate, and etching the single metal layer to form the antenna and sensing line(s). Forming the antenna and the sensing line(s) may comprise printing a metal ink on the substrate in a first pattern corresponding to the antenna. Printing may include screen, inkjet, gravure, roll-to-roll, etc. Typically, the sensing line is electrically connected to the integrated circuit via terminal(s) or bond pads on the integrated circuit. In some embodiments, the sensing line and the antenna consist of a single common metal layer on a common substrate.

Alternatively, the communication device may include a display and a battery instead of an antenna. The display may be made conventionally on a separate substrate, then attached to the smart label substrate using surface mount technology (SMT) equipment and/or processing. Alternatively, the display may be formed directly on the smart label substrate (e.g., by printing, thin film processing, roll-to-roll processing, a combination thereof, etc.). Similarly, the battery may be made conventionally on a separate substrate, then attached to the smart label substrate using SMT equipment and/or processing, or formed directly on the smart label substrate (e.g., by printing, thin film processing, roll-to-roll processing, a combination thereof, etc.).

Forming the display may comprise forming a first electrode on the smart label substrate or a separate substrate, forming a photoactive layer thereon, and forming a second electrode on the photoactive layer. Forming the display may further comprise forming a transparent window over the electrodes and photoactive layer, if necessary (e.g., the display is not formed on a transparent substrate or a substrate having a transparent window therein). At least one of the first and second electrodes may be transparent.

In addition, forming the battery may comprise forming a first current collector layer on the smart label substrate or a separate substrate, a cathode or anode thereon, an electrolyte layer on the cathode or anode, the other of the cathode or anode on the electrolyte layer, and a second current collector layer on the other of the cathode or anode. A sealant layer may be formed over the entire battery after all other layers are formed.

At 820, an integrated circuit may be formed on the substrate. Forming the integrated circuit may comprise printing one or more layers of the integrated circuit, and processing the remainder of the integrated circuit by thin film processing techniques. Alternatively, all layers of the integrated circuit may be printed. Printing offers advantages over photolithographic patterning processes, such as low equipment costs, greater throughput, reduced waste (and thus, a “greener” manufacturing process), etc., and can be ideal for relatively low transistor-count devices such as near field, RF and other tags. Furthermore, one or more layers of the integrated circuit may be printed using roll-to-roll processing.

Alternatively, the method may form all layers of the integrated circuit by one or more thin film processing techniques. Thin film processing also has a relatively low cost of ownership, and is a relatively mature technology, which can result in reasonably reliable devices being manufactured on a wide variety of potential substrates, including an MDO film. In some embodiments, the best of both approaches can be used, and the method may form one or more layers of the integrated circuit by one or more thin film processing techniques, and printing one or more additional layers of the integrated circuit.

The integrated circuit may be formed on a separate substrate and attached to the substrate on which the antenna and sensing line are formed (e.g., by pick-and-place [surface mount] technology and/or processing), or directly on the same substrate. The integrated circuit may be formed before or after the antenna and sensing line. Regardless of whether the integrated circuit is formed before or after the antenna and sensing line, terminals are formed in the integrated circuit in electric contact with ends of the antenna and sensing line, or to which the ends of each of the antenna and sensing line are electrically connected. Thus, the integrated circuit may have a first set of terminals electrically connected to the antenna. Also, the integrated circuit may have one or more terminals electrically connected to the sensing line.

At 830, an adhesive may be applied (e.g., by printing, coating, spraying, etc.) to the substrate. The adhesive may have a full adhesive strength (e.g., 100% relative to other areas and/or adhesives) in areas or regions of the substrate other than the tab (if any) and, optionally, in part or all of the tearing region. The adhesive on the tab (if any) and optionally in part or all of the tearing region may have about 25-75% (e.g., 40-60%) of the full adhesive strength. In one example, the adhesive on the tab (and optionally part or all of the tearing region) has about 50% of the adhesive strength of the adhesive on the first part of the substrate.

The different values of the adhesive strength of the adhesive may be created in the label converting process using a deadening agent or solvent. For example, the adhesive may be applied at full strength on the entire substrate. Thereafter, part or all of the adhesive may be removed from the tab and (optionally) the tearing region using the deadening agent and/or solvent. Generally, the adhesive is applied prior to any cutting or scoring of the substrate, since the substrate (which forms the label liner) provides the necessary strength for cutting and other modification operations to the substrate and/or label.

At 840, a tab, starter cuts, and/or a tearing region(s) may be formed in the substrate adjacent or proximate to the sensing line. The tab, cuts, or tearing region is/are configured to tear the substrate in the preferential tearing direction and across the sensing line. When the substrate is formed or manufactured, part of the substrate at a predetermined location adjacent to the sensing line may extend beyond a peripheral edge of the substrate to form the tab. Forming the tab (e.g., a pull tab) may also include cutting at least one slit or starter cut (e.g., perforation, score, hole, etc.) on or near the edge of the substrate. The slit(s) or cut(s) may be oriented in a direction perpendicular to the sensing line. In one example, two slits or starter cuts are made to form the tab, which advantageously allows tearing of the substrate in the preferential tearing direction and across the sensing line, and removal of a significant section of the sensing line.

Alternatively, at least one slit, notch, score and/or perforation (e.g., starter cuts) may be made at the edge of the substrate and adjacent and perpendicular to the sensing line to form a tearing region that is flush or aligned with the edge of the substrate (e.g., no extension of the substrate or tab-like structure). In one example, two slits, notches, scores and/or perforations are cut adjacent to the edge of the substrate to define the tearing region.

Alternatively, the slits, notches, scores and/or perforations (e.g., starter cuts) may be cut immediately adjacent and/or near the edge of the substrate, such that one or more gaps are formed between the starter cuts and the edge of the substrate. In addition, the starter cuts may be formed adjacent to the sensing line. In one example, two slits, notches, scores and/or perforations are cut immediately adjacent to the edge of the substrate so as to leave a gap therebetween, defining a tearing region in the substrate that advantageously facilitates tearing of the substrate and the sensing line.

Alternatively, the tearing region(s) may be formed by applying adhesive(s) in a pattern. In one example, different regions may have different adhesive strengths, as discussed above. In another example, a tearing region may be formed within the substrate by applying an adhesive to the substrate other than the tearing region, which may have little or no adhesive thereon. The tearing region of the substrate is configured to facilitate tearing the substrate and the sensing line in the preferential tearing direction of the substrate.

At 850, the substrate is placed on a package or container. Placing the substrate on the package or container may include adhering or wiping the substrate onto the package or container manually, semi-automatically, and/or automatically. Additionally, pressure and/or heat may be applied to the substrate to assist with adhering the substrate to the package or container. Subsequently, the substrate may be further secured to the package or container with shrink wrap, plastic wrap, or if the container is a bottle, a spinner and/or a capsule.

At 860, a continuity state of the package or container that the device is placed on or over may be sensed or determined using the communication (e.g., NFC and/or RF) device. The exemplary method of manufacturing the communication (e.g., NFC and/or RF) device(s) in accordance with one or more embodiments of the present invention is complete at 870.

### An Exemplary Method of Use

The present invention further concerns a method of determining a continuity state of a package or container. The method includes placing a substrate on the package or container and over an interface between first and second separable parts of the package or container, and using the integrated circuit, sensing a continuity state of the package or container. The substrate has a preferential tearing direction and a communication device thereon comprising an antenna or display, an integrated circuit, and a sensing line. The sensing line is configured to sense or determine a continuity state of a package or container on which the communication device is placed or to which the communication device is fixed or adhered. The sensing line has at least one section oriented perpendicularly or substantially perpendicularly to the preferential tearing direction of the substrate.

In various embodiments, placing the substrate on the container or package comprises adhering the substrate to the container or package. In general, the substrate is adhered to the package or container as described herein. Alternatively, the substrate/label may be held in place on the package or container and sealed in place with shrink wrap, other plastic wrap, transparent tape, a capsule, etc.

In exemplary embodiments, a first part of the substrate is adhered to the one separable part of the container or package, and a second part of the substrate is adhered to another separable part of the container or package and over the interface between the two separable parts. One part of the substrate includes the antenna, the integrated circuit, and part of the sensing line. When present, the tab may be positioned such that pulling the tab and tearing the substrate in the preferred tearing direction tears the sensing line and enables the user or consumer to open the package or container. In one example, the first part of the substrate (including the antenna and the integrated circuit) may be adhered to the first separable part of the container or package, and the second part of the substrate (including at least part of the sensing line) is adhered to the second separable part of the container or package. In this example, the tab may be positioned on or over the interface.

In some embodiments, the communication device is a wireless communication device (e.g., a near field and/or radio frequency communication device). In such embodiments, the continuity state of the package or container is sensed by reading the wireless communication device with an enabled reader (e.g., an NFC- or RF-enabled smart phone or tablet computer), and displaying the continuity state on the display of the reader. Alternatively, the communication device includes a display, and the continuity state of the package or container is sensed by the continuity sensor in the integrated circuit, then displayed on the display.

### CONCLUSION

The present invention advantageously provides ease for consumers opening packages, reduces the likelihood of a counterfeiter removing a label for placement on a generic container, and greatly increases the ease and likelihood of tearing the sensing line of a smart label having a continuity sensor thereon. In addition, the present invention advantageously ensures a cleaner tear of the sensing line and better control of the tear, which is useful for reliable function of the continuity sensor. Furthermore, the present invention advantageously provides a smart label on an MDO film. Both the antenna structure and the label structure can be formed on such a film, and proper adhesive control and/or modifications and die cutting can be integrated to create a complete label system.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. (canceled)

2. (canceled)

3. The communication device of claim 66, wherein said substrate includes a tab adjacent or proximate to said sensing line.

4. The communication device of claim 3, wherein said tab is configured to enable tearing said substrate in said preferential tearing direction and across said sensing line.

5. The communication device of claim 66, wherein the substrate comprises a machine direction oriented film and/or a label.

6. (canceled)

7. The communication device of claim 3, further comprising an adhesive on the substrate having a first adhesive strength in one or more areas other than the tab and a second adhesive strength on the tab.

8. (canceled)

9. (canceled)

10. The communication device of claim 3, further comprising at least one slit, notch, score and/or perforation immediately adjacent to and/or defining the tab, the tab configured to facilitate tearing the substrate and the sensing line.

11-21. (canceled)

22. The method of claim 67, further comprising forming a tab in said substrate adjacent or proximate to said sensing line, the tab configured to tear the substrate in said preferential tearing direction and across said sensing line.

23-25. (canceled)

26. The method of claim 22, further comprising applying an adhesive on the substrate having a first adhesive strength in one or more areas and a second adhesive strength on the tab.

27. (canceled)

28. (canceled)

29. The method of claim 67, further comprising sensing or determining a continuity state or a package or container on which the communication device is placed or to which the communication device is fixed or adhered.

30-36. (canceled)

37. A package or container, comprising:
a) first and second separable parts with an interface therebetween; and
b) the communication device of claim 66, wherein the integrated circuit is on one of the first and second separable parts of the package or container, the substrate is on or over the first and second separable parts and the interface, and the preferential tearing direction of the substrate is perpendicular or substantially perpendicular to said interface and said sensing line.

38. The package or container of claim 37, wherein said substrate comprises a tab adjacent or proximate to said sensing line, configured to tear in said preferential tearing direction and across said sensing line.

39-45. (canceled)

46. The package or container of claim 37, wherein the sensing line is on the same separable part of the package or container as the antenna and the integrated circuit.

47. The package or container of claim 46, wherein the sensing line is on the first and second separable parts of the package or container and over the interface.

48. (canceled)

49. A method of determining a continuity state of a package or container, comprising:
a) placing a substrate on the package or container and over an interface between first and second separable parts of the package or container, the substrate having a preferential tearing direction and a communication device thereon comprising an antenna or display, an integrated circuit, and a sensing line, the sensing line configured to sense or determine a continuity state of a package or container on which the communication device is placed or to which the communication device is fixed or adhered, the sensing line having at least one section oriented perpendicularly or substantially perpendicularly to said preferential tearing direction; and
b) using the integrated circuit, sensing a continuity state of the package or container.

50. The method of claim 49, wherein said substrate comprises a tab in said substrate adjacent or proximate to said sensing line, the tab configured to tear the substrate in said preferential tearing direction and across said sensing line.

51-57. (canceled)

58. The method of claim 50, wherein a first part of the substrate is adhered to the second separable part of the container or package and over the interface and a second part of the substrate including the antenna or display, the integrated circuit, the sensing line, and the tab is adhered to the first separable part of the container or package.

59. The method of claim 49, further comprising adhering (i) a first part of the substrate including the antenna and the integrated circuit to the first separable part of the container or package and (ii) a second part of the substrate including the sensing line and the tab to the second separable part of the container or package and on or over the interface.

60. (canceled)

61. (canceled)

62. The method of claim 50, further comprising tearing said tab in preferential tearing direction toward said sensing line.

63. The method of claim 62, wherein tearing said tab comprises tearing and/or removing a part of said sensing line adjacent or proximate to said tab.

64. (canceled)

65. (canceled)

66. A communication device, comprising:
a) a substrate having a preferential tearing direction;
b) an integrated circuit on or over the substrate, said integrated circuit having a first set of terminals electrically connected to an antenna or a display; and
c) a sensing line on the substrate, configured to sense or determine a continuity state of a package or container on which the communication device is placed or to which the communication device is fixed or adhered, the sensing line having at least one section oriented perpendicularly or substantially perpendicularly to said preferential tearing direction and being electrically connected to a second set of terminals of said integrated circuit different from said first set of terminals, and either:
i. a receiver and/or transmitter on the substrate and said antenna on the substrate, wherein said antenna is configured to receive a first wireless signal and/or transmit or broadcast a second wireless signal, and the integrated circuit is configured to (i) process said first wireless signal and/or information therefrom and/or (ii) generate said second wireless signal and/or information therefor; or
ii. said display on the substrate and a battery on the substrate, wherein said battery is configured to provide power to the display and the integrated circuit, and said integrated circuit is configured to provide data and/or one or more instructions to said display.

67. A method of manufacturing a communication device, comprising:
a) forming an integrated circuit on or over a substrate having a preferential tearing direction;
b) forming a sensing line on said substrate, configured to sense or determine a continuity state of a package or container on which the communication device is placed or to which the communication device is fixed or adhered, the sensing line having at least one section oriented perpendicularly or substantially perpendicularly to said preferential tearing direction;
c) electrically connecting said sensing line to a second set of terminals of the integrated circuit; and either:
i) forming an antenna on said substrate, wherein said antenna is configured to receive and/or transmit or broadcast a wireless signal, and said antenna is electrically connected to a first set of terminals in the integrated circuit; or
ii) forming a display on or over said substrate, wherein said display is configured to display a continuity state of the package or container, and said display is electrically connected to said first set of terminals.
